(19) United States
(12) Patent Application Publication
(10) Pub. No.: US 2014/0279452 A1
(43) Pub. Date: Sep. 18, 2014

(54) VENDOR PROPENSITY ANALYSIS COMPONENT FOR AN ELECTRONIC INVOICE PAYMENT SYSTEM

(71) Applicant: BOTTOMLINE TECHNOLOGIES (DE) INC., Portsmouth, NH (US)

(72) Inventor: Peter HITCHMOTH, Stratham, NH (US)

(73) Assignee: BOTTOMLINE TECHNOLOGIES (DE) INC., Portsmouth, NH (US)

(21) Appl. No.: 13/834,425

(22) Filed: Mar. 15, 2013

(51) Int. Cl. G06Q 20/10

(52) U.S. Cl. CPC G06Q 20/102
USPC 705/40

(57) ABSTRACT

An electronic invoice payment system includes a database stored on a non-transitory computer readable medium, the database including a plurality of vendor records containing information pertaining to a plurality of vendors. A network interface is configured to receive presented invoices from multiple vendors for payment by multiple buyers. A processor is configured to analyze at least a portion of the vendor records to determine whether a subject vendor selected from among the plurality of vendors satisfies one or more predetermined criteria, and when so, to calculate a vendor propensity factor that operates as a measure of the subject vendor's propensity to participate in an aspect of the electronic invoice payment system. The processor further is configured to generate a vendor propensity record including the vendor propensity factor for the subject vendor.

### TECHNICAL FIELD

The present invention relates to an electronic invoice payment system, and more particularly to systems and methods for analyzing vendor behavior propensities in such an electronic invoice payment system. The vendor behavior propensities may be employed to tailor services for vendors in the electronic invoice payment system.

### BACKGROUND OF THE INVENTION

Traditional invoice presentment and payment solutions between vendors and their buyers include paper-based invoice presentment and payment. In this scenario, the steps required to send an invoice (on the vendor's side), and receive, approve, and pay the invoice (on the buyer's side) rely on a series of paper-based procedures. Recently, electronic invoicing and payment systems have been developed that provide on-line and network based invoice presentment by the vendor and electronic funds transfer (EFT) payment by the buyer. In electronic invoice and payment systems, vendors still issue and present invoices to buyers (also referred to herein as payers).

Due to the scope, volume, and value amounts of electronic invoices being processed in the modern economy, a business model has been developed by which a third party processes invoices and related payments on behalf of buyers and vendors. A third party invoice processing entity may be a service provider that processes invoices for multiple participating vendors and buyers as part of a fee based service. In such a system, each presented invoice would be associated with a buyer for payment, and multiple invoices from various vendors may be associated with various buyers. The number and types of vendors and buyers participating in the electronic invoice and payment system operated by the third party service provider may vary extensively.

Due to the competitive business atmosphere in today's economy, it is generally desirable for vendors to avoid having to pass on costs and fees for third party invoice processing onto their customers, the buyers. Accordingly, in more recently developed business models involving third party invoice processing, vendors have tended to bear the gravamen of the costs and fees paid to the third party processing entity. This presents an issue for the third party processing entity in marketing its own services for use by vendors. Third party processing entities must demonstrate to vendors that the services being provided have value to the vendors that is substantially greater than the fees being paid. Generally, third party processing entities market their services to vendors as having value in providing faster payments, payments on a more certain time table, more secure payments, and the like, as compared to conventional invoice processing by which vendors present, process, and collect on their own invoices. Still, such potential advantages must be marketed and demonstrated to vendors.

In this regard, the advantages of third party invoice processing can vary. Depending on circumstances, different vendors may benefit from third party invoice processing more than other vendors. Currently, however, a third party processing is entity has no way of measuring vendors' propensities toward participating in a third party invoice processing system. In conventional systems, therefore, third party processing entities tend to market their services to vendors essentially on a vendor by vendor basis without regard to whether a vendor would have a propensity to join the service. The result is a cumbersome, inefficient process for adding participating vendors to an invoice processing system, to the effect that the advantages of such systems are not being fully realized. For example, vendors who could benefit substantially from such a system may not be identified, and the third party processing entity may not be fully realizing its own economic potential of providing such services.

### SUMMARY OF THE INVENTION

There is a need in the art for an improved electronic invoice system and related methods that provide an algorithm to predict or identify a vendor's propensity to participate in a third party invoice processing system. An aspect of the invention, therefore, is an improved electronic invoice processing system that has a vendor propensity analysis feature. The vendor propensity analysis feature may predict or identify a vendor's propensity to engage in certain behaviors associated with participation in a third party invoice processing system. Such behaviors, for example, may include whether a vendor is willing to join and participate in such a system at all, if so what types and amounts of fees may be acceptable to the vendor to pay the third party processing entity, what services may be desirable to the vendor, the willingness of the vendor to participate in or negotiate with a purchasing consortium, and the like.

The determination of vendor propensity may be based on one or more predetermined criteria. In exemplary embodiments, the predetermined criteria may be based on a buyer side analysis of buyer characteristics, insofar as a vendor for a particular buyer may have like propensities as other vendors common to the buyer that is subjected to the buyer side analysis. In other exemplary embodiments, the predetermined criteria may be based alternatively or additionally on a vendor side analysis of vendor characteristics, insofar as a vendor may have propensities common with other vendors having like characteristics or under like circumstances as determined by the vendor side analysis.

Vendor propensities, once determined, may then be utilized as part of a vendor outreach program to identify vendors with a propensity to participate in one or more aspects of a third party invoice processing system. For example, vendor propensities may be utilized to tailor solicitations to the vendor, offer services provided to the vendor, and set fees to be charged in view of the determined vendor propensities.

Accordingly, an aspect of the invention is an electronic invoice payment system. Exemplary embodiments of the electronic invoice payment system include a database stored on a non-transitory computer readable medium, the database including a plurality of vendor records containing information pertaining to a plurality of vendors. A network interface is configured to receive presented invoices from multiple vendors for payment by multiple buyers. A processor is configured to analyze at least a portion of the vendor records to determine whether a subject vendor selected from among the plurality of vendors satisfies one or more predetermined criteria, and when the processor determines that the subject vendor satisfies the one or more predetermined criteria, to calculate a vendor propensity factor that operates as a measure of the subject vendor's propensity to participate in an aspect of the electronic invoice payment system. The processor further is configured to generate a vendor propensity record including the vendor propensity factor for the subject vendor.

In an exemplary embodiment of the electronic invoice payment system, the one or more predetermined criteria comprises criteria based on a buyer side analysis of the portion of the vendor records.

In an exemplary embodiment of the electronic invoice payment system, the buyer side predetermined criteria include that the subject vendor shares a common buyer with other vendors participating in the electronic invoice payment system.

In an exemplary embodiment of the electronic invoice payment system, the buyer side predetermined criteria include at least one of that the subject vendor presents invoices to a corresponding buyer on a regular periodic basis, that the subject vendor presents invoices to the corresponding buyer above a predefined threshold number of invoices within a predefined time period, or that the subject vendor presents invoices to the corresponding buyer above a predefined threshold value.

In an exemplary embodiment of the electronic invoice payment system, the one or more predetermined criteria comprises criteria based on a vendor side analysis of the portion of the vendor records.

In an exemplary embodiment of the electronic invoice payment system, the vendor side predetermined criteria include that the subject vendor accepts one or more forms of electronic payment and accepts such electronic payments in a percentage of transactions above a predefined threshold amount.

In an exemplary embodiment of the electronic invoice payment system, the vendor side predetermined criteria include that the subject vendor sell products of a predefined product identity.

In an exemplary embodiment of the electronic invoice payment system, the vendor side predetermined criteria include that the subject vendor operates within a predefined industry.

In an exemplary embodiment of the electronic invoice payment system, the vendor side predetermined criteria include that the subject vendor within the predefined industry is eligible for at least one of joining or negotiating with a purchasing consortium.

In an exemplary embodiment of the electronic invoice payment system, the one or more predetermined criteria are stored in the database.

In an exemplary embodiment of the electronic invoice payment system, the vendor propensity indicator is a flag indicator stored in the database that is indicative that the subject vendor has a positive propensity for participating in the electronic invoice payment system.

In an exemplary embodiment of the electronic invoice payment system, the one or more predetermined criteria comprises a plurality of predetermined criteria, and the vendor propensity factor comprises a calculated ranking that operates as a measure of a degree of compliance with the plurality of predetermined criteria.

In an exemplary embodiment of the electronic invoice payment system, the vendor propensity factor is indicative of the subject vendor's propensity to participate in one or more aspects of the electronic invoice payment system.

In an exemplary embodiment of the electronic invoice payment system, the one or more aspects of the electronic invoice payment system comprises at least one of scheduling payments automatically, processing payments automatically, accelerating payments, consolidating payments, adding security features to payment processing, facilitating the joining of a vendor purchasing consortium, facilitating negotiations with a buyer purchasing consortium, or a fee structure.

In an exemplary embodiment of the electronic invoice payment system, when the processor determines that the subject vendor does not satisfy the one or more predetermined criteria, the processor further is configured to exclude the vendor as a candidate for participating in the electronic invoice payment system.

In an exemplary embodiment of the electronic invoice payment system, the processor further is configured to update the vendor propensity record.

In an exemplary embodiment of the electronic invoice payment system, the processor further is configured to: access the vendor propensity record for the subject vendor, extract the vendor propensity factor from the vendor propensity record, analyze the vendor propensity factor to determine whether the vendor propensity record indicates the subject vendor has a propensity to participate in an aspect of the electronic invoice payment system, and when the processor determines that the subject vendor has a propensity to participate in the aspect of the electronic invoice payment system, to generate a vendor outreach message as to participation by the subject vendor in the aspect of the electronic invoice payment system.

In an exemplary embodiment of the electronic invoice payment system, the processor further is configured to transmit the vendor outreach message to a vendor electronic device via the network interface.

A number of features are described herein with respect to embodiments of the invention. It will be appreciated that features described with respect to a given embodiment also may be employed in connection with other embodiments. In addition, for a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a schematic block diagram depicting an exemplary architecture of an electronic invoice presentment and payment system in accordance with an exemplary embodiment of the present invention.

FIG. 2 is a schematic block diagram representing a buyer system in accordance with an exemplary embodiment of the present invention.

FIG. 3 is a schematic block diagram representing a vendor system in accordance with an exemplary embodiment of the present invention.

FIG. 4A is a diagram representing an invoice database structure in accordance with an exemplary embodiment of the present invention.

FIG. 4B is a diagram representing an invoice database object in accordance with an exemplary embodiment of the present invention.

FIG. 4C is a diagram representing a vendor record in accordance with an exemplary embodiment of the present invention.

FIG. 5 is a flow chart diagram depicting an overview of an exemplary method of generating a vendor propensity record indicative of a subject vendor's propensity to participate in an aspect of an electronic invoice payment system.

FIG. 6 is a flow chart diagram depicting an overview of an exemplary method of executing a vendor outreach program.

FIG. 7 is a diagram depicting an exemplary graphical user interface (GUI) for use in connection with an electronic invoice payment system.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions that are encoded within non-transitory computer readable media accessible to the processor, or a combination of a hardware circuit(s) and a processor or control block of an integrated circuit executing machine readable code encoded within a non-transitory computer readable medium. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a non-transitory computer readable medium, or a combination of a hardware circuit(s) and a processor and/or control block executing such code.

The present invention provides a system and methods that provide an algorithm to predict or identify a vendor's propensity to participate in one or more aspects of a third party invoice processing system. An improved electronic invoice system thus has a vendor propensity analysis feature. The vendor propensity analysis feature may predict or identify a vendor's propensity to engage in certain behaviors associated with participation in a third party invoice processing system. Such behaviors, for example, may include whether a vendor is willing to join and participate in such a system at all, if so what types and amounts of fees may be acceptable to the vendor to pay the third party processing entity, what services may be desirable to the vendor, the willingness of the vendor to participate in or negotiate with a purchasing consortium, and the like.

The determination of vendor propensity may be based on one or more predetermined criteria. In exemplary embodiments, the predetermined criteria may be based on a buyer side analysis of buyer characteristics, insofar as a vendor for a particular buyer may have like propensities as other vendors common to the buyer that is subjected to the buyer side analysis. In other exemplary embodiments, the predetermined criteria may be based alternatively or additionally on a vendor side analysis of vendor characteristics, insofar as a vendor may have propensities common with other vendors having like characteristics or under like circumstances as determined by the vendor analysis.

FIG. 1 depicts an exemplary architecture 11 for electronic invoicing, including an electronic invoicing and payment system 9. The exemplary electronic invoicing and payment system 9 may include a payment application 18 and an invoice application 19, each of which may be instructions coded and stored on a non-transitory computer readable medium and executed by a processing device, such as the processor 40. The electronic invoicing and payment system 9 (sometimes referred to herein in short form as invoice payment system 9) provides on-line invoice presentment that includes modules for reporting invoice approval and payment status to the vendors 12. In general, the invoice application 19 electronically delivers invoices initiated by a vendor 12 to the applicable buyer 14, and includes a reporting function that provides vendors invoice status information. For example, a vendor may submit an invoice to a buyer via the invoicing application. The invoice may then be automatically entered into an accounts receivable system of the buyer. In one example, the status of the invoice may be updated to “received” such that the vendor may view the status of the invoice to verify that the invoice has been received by the buyer. At this point, the buyer may approve the invoice for payment and the status of the invoice may be updated again to indicate approval for payment, which the vendor may view. Upon approving the invoice for payment, the invoice payment system 9 may execute payment from the buyer's financial account, such as a bank or credit account, to the vendor. For this purpose, the invoice payment system 9 may be communicatively coupled to a financial institution in which the buyer has an account or credit line, such as the financial institution 28 in FIG. 1.

In exemplary embodiments, the electronic invoicing and payment system 9 would be operated by a third party invoice processing entity. The third party invoice processing entity may be a service provider that processes invoices for multiple participating vendors as part of a fee based service. In such a system, each presented invoice would be associated with a buyer for payment, and in turn made accessible to the associated buyer as part of the invoice processing. Accordingly, multiple invoices from various vendors may be associated with various buyers. The number and types of vendors and buyers participating in the electronic invoice and payment system operated by the third party service provider may vary extensively.

Such an exemplary electronic invoicing and payment system is further described in U.S. patent application Ser. No. 13/068,558 filed on May 13, 2011, the entire contents of which are incorporated by reference herein. Other exemplary invoice and payment systems include systems that utilize the automated clearing house (ACH) payment system, wire transfers, electronic check and bank transfers, and other electronic fund transfer (EFT) systems that may be part of card payment networks, such as networks operated by Visa, MasterCard, and American Express, and the like.

The electronic invoicing and payment system 9 may be a computer system including one or more servers comprising at least a processor 40, a network interface 21, and computer readable medium 42. The computer readable medium 42 may be a non-transitory computer readable medium that includes encoded thereon a database 118. The database 118 may include data structures, also referred to as tables, as described herein and may include instructions embodied on computer readable medium 42 for interfacing with the network interface 21 for reading and writing data to the data structures and tables.

The network interface 21 may be communicatively coupled to each buyer 14a-14f of a community of buyers 14, and to each vendor 12a-12f of a community of vendors 12 via a network 20. It will be appreciated that the specific number and nature of the vendors 12 and buyers 14 may vary substantially. The network 20 may be an open network, such as the Internet, a private network, such as a virtual private network, or any other suitable network. The network interface 21 may receive invoices and invoice updates from the vendors 12 and/or buyers 14. For example, the network interface 21 may be configured to enable, for a given invoice, updating of the status of at least one event associated with approval and payment of the given invoice based on a received invoice update. The network interface 21 may include a wireless network adaptor, an Ethernet network card, or any suitable device that provides an interface between the invoice payment system 9 and the network 20.

The invoices and invoice updates received by the network interface 21 may be stored in an invoice database 160 contained in the database 118. The invoices may be stored in the invoice database 160 as records. Each record corresponds to an invoice and may identify an associated vendor, an associated buyer, and contain status information. The invoice database may store records corresponding to different combinations of associated vendors and buyers. The status information may correspond to activity of the associated buyer and/or vendor in relation to a given invoice and may include any combination of a current status, a current status update timestamp indicating the date when the invoice status was last updated, a list of past statuses, and, for each of the past statuses in the list of past statuses, a past status timestamp indicating the date when the past status was updated.

The records stored in the invoice database 160 may correspond to invoices for which payment has been received (“paid invoices”) and/or invoices for which payment has not been initiated (“unpaid invoices”). The invoice status updates received by the network interface 21 may be used to update the status of invoices stored in the invoice database 160. For example, the invoice updates may include a status update that payment for a given invoice was initiated. Under such circumstances, the status of an invoice may be altered from “unpaid invoice” to “payment initiated” invoice. Upon final settlement of the payment transaction, the status of an invoice may then be updated again to “payment received”. The timestamp associated with the various statuses are updated commensurately with the status updates to indicate, for example, when payment was initiated and when payment has been received (i.e., settled).

As will be understood by those of ordinary skill in the art, the database 118 may describe a data structure which embodies groups of records or data elements stored in a volatile or non volatile storage media and accessed by an application, which may be instructions coded to a storage medium and executed by a processor. The database may include multiple individual databases stored on the same storage medium or on multiple different storage media. While the database 118 is depicted as a component of the invoice payment system 9 in FIG. 1, the database 118 could alternatively be stored on a separate server or locally, for example, on a buyer's computer and/or on a vendor's computer.

The processor 40 may constitute an electronic controller that is configured to carry out overall control of the functions and operations of the electronic invoice payment system 9. The processor 40 may include a processing device such as a CPU, microcontroller or microprocessor. To implement the features of the present invention, the processor may be configured to execute program code embodied as a vendor propensity analysis application 17. Although shown as a distinction application, in another embodiment the computer readable medium 42 may include encoded thereon the vendor propensity analysis application 17, or the vendor propensity analysis application 17 may be stored on a non-transitory computer readable medium separate from the invoice payment system 9. Regardless of its location, therefore, the vendor propensity analysis application 17 may be a computer program comprising instructions embodied on a non-transitory computer readable medium 42 and executed by a processor, such as the processor 40.

It will be apparent to a person having ordinary skill in the art of computer programming of electronic devices and servers how to program the components of the invoices payment system to operate and carry out logical functions associated with the vendor propensity analysis application 17. Accordingly, details as to specific programming code have been left out for the sake of brevity. Also, controller functionality could be carried out via dedicated hardware, firmware, software, or any combinations thereof, without departing from the scope of the invention. As will be understood by one of ordinary skill in the art, therefore, the processor 40 may have various implementations. For example, the processor 40 may include any suitable device, such as a programmable circuit, integrated circuit, memory and I/O circuits, an application specific integrated circuit, microcontroller, complex programmable logic device, other programmable circuits, or the like. The processor 40 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor.

Referring to FIG. 2 in conjunction with FIG. 1, in an exemplary embodiment, each buyer, such as buyer 14a for example, may be a business that includes at least one computer system or server 46. The computer system(s) or server(s) 46 may include at least one processor 50 and associated computer readable medium 52 programmed with an accounts payable application 54. In a typical environment, the computer system(s) or server(s) 46 operating the accounts payable application 54 may be coupled to a local area network (LAN) 44 and accessed by entitled users of workstations 48 and may be used for managing the buyer's accounts payables and issuing payments to its vendors. Each buyer, again using buyer 14a as an example, may further include one or more access systems for interfacing with the payment acceleration system 10. Exemplary access systems include: i) a web browser 49a on a workstation 48 or other computer which accesses system 10 via a web connection; ii) a tablet computer 49b such as an iPad or Windows Surface which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

Referring to FIG. 3 in conjunction with FIG. 1, in an exemplary embodiment, each vendor, such as vendor 12a for example, may be a business that includes at least one computer system or server 56. The computer system(s) or server(s) 56 may include at least one processor 58 and associated computer readable medium 64 programmed with an accounts receivable application 66. In a typical environment, the computer system(s) or server(s) 56 operating the accounts receivable application 66 may be coupled to a local area network (LAN) 62 and accessed by entitled users of workstations 60 and may be used for issuing invoices and managing the vendor's accounts receivables and reconciling payments issued by customers (i.e. buyers) against amounts due to the vendor. Each vendor, again using vendor 12a as an example, may further include one or more access systems for interfacing with the system 10. Similarly as to the buyers, exemplary vendor access systems include: i) a web browser 61a on a workstation 60 or other computer which accesses system 10 via a web connection; ii) a tablet computer 61b such as an iPad or Windows Surface which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, a participating financial institution 28 is depicted. The financial institution 28 may be a bank or like institution that can hold accounts of the vendor and buyers and process payment transactions. The financial institution 28 may include a payment system (i.e. instructions coded to a computer readable medium and executed by a processor) which may manage customer deposit accounts 36 for at least a portion buyers 14 and/or a portion of the vendors 12, including execution of credit and debit transactions to specific deposit accounts 36a-36e in a traditional manner.

Referring to FIG. 4A in conjunction with FIG. 1, the database 118 may further include, as one of the data structures, the invoice database 160 as described previously. The invoice database 160 may include a plurality of records 162, with each record 162 corresponding to an invoice. Each invoice 162 associates a unique invoice ID 164 with a unique invoice object 166 and a group of exemplary status fields. In the exemplary embodiment of FIG. 4A, the status fields may include an invoice received status field 168, a pending invoice approval status field 170, an invoice approved status field 172, a set for payment status field 174, a first approved to pay status field 176a, a second approved to pay status field 176b, a payment initiated status field 178, a payment received field 179, and a disputed invoice status field 180. As stated previously, the invoice status is not limited to the above listed statuses. For example, the invoice statuses may fall under one of three global statuses (e.g., in process, rejected for processing, ready for payment). As another example, the invoice statuses may include default statuses and/or user defined statuses.

Each status field represents a completed step within a group of processing steps the buyer performs to approve and pay the invoice, whether within the invoice application 19 itself or within the buyer's accounts payable system 43 (FIG. 2) (or both) represented by the record 162. For example, the invoice received status field 168 may represent an initial step at which the buyer has completed receipt of the invoice into his accounts payable system. Additionally, the pending approval status field 170 may represent steps following receipt of the invoice which are performed by the buyer prior to formal approval of the invoice. The approved status field 172 may represent formal approval of the invoice. The set for payment status field 174 may represent a step of setting the payment of the invoice. The first approved to pay status field 176a may represent approval of the payment. The second approved to pay status field 176b may be an optional step representing a second level approval of the payment. The optional step 176b may apply based on the buyer's approval rules, for example, high value payments may require a second level of approval. The payment initiated status field 178 may represent the buyer initiating the payment through the payment acceleration system 10, such as by issuing a payment order. The payment received status field 179 may represent the vendor's receipt of the payment through the payment acceleration system 10. The disputed status field 180 may represent the buyer disputing all or a portion of the invoice.

Each status field may operate as a status flag for that processing step in that whether the value is populated, or whether a particular value is populated, indicates whether the buyer has completed the processing step. In the exemplary embodiment, each of the status fields may be populated with the status timestamp (i.e., the date and time that the process was completed).

Referring to FIG. 4B, an exemplary invoice object 166 may include a header 182 and a body 184. The header 182 may include a vendor ID 186 and a buyer ID 188 identifying the vendor issuing the invoice and the buyer to which the invoice is delivered. The body 184 of the invoice object includes invoice data. The invoice data may include data components of a standardized XML data schema 190, which may be an invoice data schema standardized by the ISO 20022 standard. The invoice data may also include attachments 192, which would typically be PDF files but could be attachments in other file formats, which provide more detailed information about invoice line items. The invoice object 166 also may include an amount field 194 indicating the amount of the invoice.

Referring again to FIG. 4A, within the records 162 of the invoice database 160 are invoice objects 166 as depicted in FIG. 4B, such as at least a first invoice object (Invoice ID 001 for example) which includes identification of a first vendor (Vendor A for example) and at least a second invoice object (Invoice ID 004 for example) which includes identification of a second vendor (Vendor B for example) unique from the first vendor. Each vendor is a distinct organization with responsibility for issuing and collecting on its own invoices. Also within the records 162 of the invoice database 160 are at least a first invoice object (Invoice ID 001 for example) which includes identification of a first buyer (Buyer B for example) and at least a second invoice object (Invoice ID 002 for example) which includes identification of a second buyer (Buyer C for example) unique from the first buyer. Each buyer is a distinct organization with responsibility for payment of invoices distinct from other buyers. In this manner, vendor invoices are associated with respective buyers via the invoice objects 166.

For example, the record 162 with an invoice ID 164 of “001” may include an invoice 166 issued by Vendor A to Buyer B. For purposes of illustrating the invention, it is assumed that all processes have been completed and a date is populated to each field. A second level approval step 176b is not required. The record 162 with an invoice ID of “002” may include an invoice 166 issued by Vendor A to Buyer C. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The additional records with invoice IDs 003 on may be described in similar fashion. Specifically, the record 162 with an invoice ID of “003” may include an invoice 166 issued by Vendor A to Buyer D. For purposes of illustrating the invention, it is assumed that Buyer D has a dispute regarding this invoice. As such only a date is populated to the invoice received status field 168 and a dispute code “Code 4” is populated to the disputed field. A dispute code table 300 may associate a group of dispute codes, for example dispute codes “Code 1”, “Code 2”, “Code 3”, and “Code 4” with a dispute reason. For example, “Code 1” may represent dispute a first reason “Reason A” and “Code 2” may represent a second dispute reason “Reason B”, which is distinct from dispute “Reason A”. A fourth dispute reason “Code 4” may be generic and represent buyer text input of a message to the vendor regarding the basis for the dispute.

The record 162 with an invoice ID of “004” may include an invoice 166 issued by Vendor B to Buyer A. For purposes of illustrating the invention, it is assumed that Buyer A has performed only the first two sequential processing steps (invoice received 168 and pending approval 170). As such, dates are populated for invoice received 168 and pending approval 170. A second level approval step 176b is required for this invoice.

The record 162 with an invoice ID of “005” may include an invoice 166 issued by Vendor B to Buyer B. For purposes of illustrating the invention, it is assumed that Buyer B has performed only the first processing step (invoice received 168). As such, dates are populated for invoice received 168 and pending approval 170. A second level approval step 176b is required for this invoice.

The record 162 with an invoice ID of “006” may include an invoice 166 issued by Vendor A to Buyer B. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The record 162 with an invoice ID of “007” may include an invoice 166 issued by Vendor A to Buyer F. For purposes of illustrating the invention, it is assumed that the second level approval step 176b is required and that Buyer F has performed all of the sequentially processing steps, including second level pending approval to pay 176b, except for the payment initiated Step 178. As such, dates are populated for invoice received 168, pending approval 170, pending approval 172, set for payment 174, first level pending approval to pay 176a, and second level pending approval to pay 176b.

As referenced above, one deficiency of conventional electronic invoice payment systems is that third party processing entities necessarily tend to market their services to vendors essentially on a vendor by vendor basis without regard to whether a vendor would have a propensity to join the service. The result is a cumbersome, inefficient process for adding participating vendors to an invoice processing system, to the effect that the advantages of such systems are not being fully realized. For example, vendors who could benefit substantially from such a system may not be identified, and the third party processing entity may not be fully realizing its own economic potential of providing such services. The claimed invention overcomes such deficiencies by analyzing transaction circumstances to identify vendors with a propensity toward participating in the third party processing system, and relatedly identifying vendor propensities toward participating in specific aspects of such system.

Referring again to FIG. 1, the electronic invoice payment system 9 further may include a vendor database 200 that contains information pertaining to a plurality of vendors who potentially may participate in the system. The vendor database 200 may be part of the database 118 stored on the non-transitory computer readable medium 142, or may be stored as a separate database. The vendor database 200 contains various vendor information that would permit the system to analyze a subject vendor determine the subject vendor's propensity for participating in one or more aspects of the electronic invoice payment system.

FIG. 4C is a diagram representing an exemplary vendor record 202. Numerous vendor records may be stored in the vendor database 200 of FIG. 1. Information stored in a vendor record, for example, may include vendor identification information (Vendor ID 204). The vendor record further may include additional vendor information 206 about the vendor, such as, for example, information as to the industry or industries in which the vendor may operate (Industry ID(s)), product or products sold by the vendor (Product ID(s)), contact information, buyer information pertaining to associated buyers who already may be participating in the system, and the like. It will be appreciated that the precise format and content of the stored vendor records 202 within the vendor database 200 may be varied. The vendor information may be derived at least in part by extracting information contained in the invoice objects and records stored within the invoice database 160. Vendor information also may be obtained via independent market research and added to the vendor database. The vendor information, therefore, may be gathered by any suitable means. Generally, as further explained below, the vendor information is employed to perform a vendor propensity analysis to determine a vendor's propensity to participate in aspects of the electronic invoice payment system.

An aspect of the invention, therefore, is an improved electronic invoice payment system, such as the electronic invoicing and payment system 9. Exemplary embodiments of the electronic invoice payment system include a database stored on a non-transitory computer readable medium, such as the database 118 storing the database of vendor records 200. The database includes a plurality of vendor records containing information pertaining to a plurality of vendors. A network interface, such as network interface 21, is configured to receive presented invoices from multiple vendors for payment by multiple buyers. A processor, such as processor 40, is configured to analyze at least a portion of the vendor records to determine whether a subject vendor selected from among the plurality of vendors satisfies one or more predetermined criteria, and when the processor determines that the subject vendor satisfies the one or more predetermined criteria, to calculate a vendor propensity factor that operates as a measure of the subject vendor's propensity to participate in an aspect of the electronic invoice payment system. The processor further is configured to generate a vendor propensity record including the vendor propensity factor for the subject vendor. The processor may be configured to perform such operations by the execution of a vendor propensity analysis application, such as vendor propensity analysis application 17.

As illustrative of the operation of such an electronic invoice payment system 9, FIG. 5 is a flow chart diagram depicting an overview of an exemplary method of generating a vendor propensity record indicative of a subject vendor's propensity to participate in an aspect of the electronic invoice payment system. In exemplary embodiments, the electronic invoice payment system 9 of FIG. 1 is configured to execute the described method, such as by the processor 40 executing code embodied as the vendor propensity analysis application 17 stored on a non-transitory computer readable medium (e.g., medium 42). Accordingly, in demonstrating the method, reference also is made to the electronic invoice payment system 9 as depicted in FIG. 1. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 300, at which the system accesses at least a portion of the vendor records. For example, the processor 40 executing the vendor propensity analysis application 17 may access the vendor records 202 (see FIG. 4C) contained in the vendor database 200. As described above, the vendor records may be based on information received by the electronic invoice payment system 9 from multiple vendors and buyers via the network interface 21, or added by independent market research. At step 310, the electronic invoice payment system 9 identifies a subject vendor based on the vendor records. The subject vendor may be selected manually by a user, or through an automated process that would periodically analyze vendors referenced in the vendor records.

At step 320, the electronic invoice payment system 9 analyzes at least a portion of the vendor records to determine whether the identified subject vendor satisfies one or more predetermined criteria. The electronic invoice payment system may analyze the portion of the invoice records as part of the processor 40 executing the vendor propensity analysis application 17. The electronic invoice payment system 9 may receive the predetermined criteria based on inputs by the third party processing entity via a processing entity workstation 16 (see FIG. 1). The predetermined criteria may be stored as part of the database 118 for use in the analysis by the processor 40. As further explained below, the predetermined criteria are defined so as to be indicative of whether the subject vendor has a propensity toward participating in aspects of the electronic invoice payment system

In exemplary embodiments, the predetermined criteria may be based on a buyer side analysis of the portion of the invoice records. Such analysis at least in part is premised on the notion that vendors who are common to a given buyer would tend to have a propensity towards comparable participation in the system. Referring back to FIG. 4A showing the invoice records, for example, Buyer B buys from different Vendors A and B who are participants in the electronic invoice payment system. Accordingly, a hypothetical “Vendor C” who also buys from Buyer B is likely to have a propensity toward participating in aspects of the electronic invoice payment system, comparably as Vendors A and B. A user may have researched Vendor C and entered a record for Vendor C into the vendor database, including associated buyer information (see FIG. 4C) pertaining to Buyer B. In actuality, a large manufacturer, for example, may be a buyer for numerous (even dozens or more) supplier vendors. Invoice processing efficiencies would be substantially enhanced if all such vendors were to participate in a common manner in the electronic invoice processing system. A predetermined criterion, therefore, may be that the subject vendor shares a common buyer with other vendors participating in the electronic invoice payment system.

Other predetermined criteria based on a buyer side analysis may relate to the buyer's payment relationships with the subject vendor. For example, recurring payments, by which a buyer purchases a product on a regular periodic basis (e.g., monthly, quarterly), tend to be suitable to the automatic nature typically associated with an electronic invoice payment system. A vendor that presents invoices in such a recurring manner should have a propensity toward participating in aspects of an electronic invoice payment system. A predetermined criterion, therefore, may be that the subject vendor presents invoices to a corresponding buyer on a regular periodic basis. Even if such invoices may not recur periodically, a vendor who presents numerous invoices to a buyer within a predefined time period (e.g., monthly, quarterly) also would tend to benefit from the automatic nature of an electronic invoice payment system. All such information may form part of the associated buyer information that is entered as part of the vendor record, which can then be compared to the invoice records for the associated buyer. A predetermined criterion, therefore, may be that the subject vendor presents invoices to a corresponding buyer above a predefined threshold number of invoices within a predefined time period.

Similarly, the automatic nature of an electronic invoice payment system tends to benefit vendors substantially for high value payments. For high value payments, vendors benefit from increased timeliness, certainty, and security afforded by an electronic invoice payment system. A vendor that regularly presents high value invoices to a corresponding buyer should have a propensity toward participating in aspects of an electronic invoice payment system. A predetermined criterion, therefore, may be that the subject vendor presents invoices to a corresponding buyer above a predefined threshold value or amount.

In exemplary embodiments, the predetermined criteria additionally or alternatively may be based on a vendor side analysis of the portion of the vendor records. All the pertinent information as to such criteria generally may be stored as part of the vendor information 206 within the vendor record 202.

For example, vendors who regularly accept one or more forms of electronic payment (e.g., credit or debit cards, automated clearing house (ACH) transfers, wire transfers, other electronic fund transfers (ETFs)) generally have been known to have a greater propensity to join an electronic invoice payment system managed by a third party processing entity as compared to vendors who largely engage in non-electronic transactions. A predetermined criterion, therefore, may be that the subject vendor accepts one or more forms of electronic payment and accepts such electronic payments in a percentage of transactions above a predefined threshold amount (e.g., 75% electronic, 90% electronic, etc.).

Another category of vendor side analysis may be based on a vertical industry analysis. Under a vertical industry analysis, vendors who are common to a given industry (e.g., healthcare, automotive, etc.) are deemed to have a propensity to act in a like manner. In a simple example application of a vertical industry type analysis, certain products or categories of products may be determined to be more suitable to invoicing and payment via an electronic invoice payment system. Vendors who sell such products, therefore, should have an increased propensity to participate in aspects of an electronic invoice payment system. A predetermined criterion, therefore, may be that the subject vendor sells products of a predefined product identity.

In a more sophisticated form of a vertical industry based analysis, it is known that vendors and/or buyers in certain industries sometimes form purchasing consortiums. In a purchasing consortium, buyers or vendors band together to increase their marketing power. On the buyer side, buyers can increase purchasing power by banding together to purchase common products in bulk at discounted prices as compared to purchases made as individual entities. For example, it is known that hospitals and similar healthcare entities form purchasing consortiums to purchase staple or commodity type items in bulk (e.g., sterile gloves, cleaning supplies, linens, and the like). On the vendor side also, vendors can form purchasing consortiums to better market larger amounts and values of products as compared to the capabilities of the vendors acting individually. Due to the substantial amounts and value of products being moved and invoiced in industries with purchasing consortiums, vendors in such industries would tend to benefit from the automatic nature of an electronic invoice payment system. Accordingly, it is likely that vendors in such industries would have a greater propensity to participate in aspects of an electronic invoice payment system as compared to vendors who are not in such industries. A predetermined criterion, therefore, may be that the subject vendor operates within a predefined industry, or more specifically in a predefined industry and is eligible for at least one of joining or negotiating with a purchasing consortium.

It will be appreciated that the various predetermined criteria described above are but examples. Any suitable criteria may be employed for determining the propensity of a vendor to participate in aspects of an electronic invoice payment system. In addition, the predetermined criteria may be applied singularly or in any combination of multiple criteria, including combining one or more buyer side analysis criteria with one or more vendor side analysis criteria.

Referring again to FIG. 5, if at step 320 the electronic invoice payment system renders a “No” determination, indicating that the subject vendor does not meet the one or more predetermined criteria, the method proceeds to step 330 at which the subject vendor is excluded as a candidate with a propensity for participation in the electronic invoice payment system. In such case, having not met any of the predetermined criteria, the subject vendor is deemed not to have a propensity to participate in the third party electronic invoice payment system. As a result, in formulating a vendor outreach program, the third party processing entity may exclude the subject vendor from the vendor outreach so as to avoid the effort and expense of soliciting a vendor who is unlikely to join in the system. It will be appreciated that such exclusion from the vendor outreach program need not be permanent. For example, the vendor may be identified in the future as a subject vendor, and vendor circumstances may change so that at some time the vendor may satisfy the one or more predetermined criteria. At such time, the subject vendor would no longer be deemed as an excluded vendor at the decision step 320.

If at step 320, however, the electronic invoice payment system renders a “Yes” determination, indicating that the subject vendor does in fact meet the one or more predetermined criteria, the method proceeds to step 340. At step 340, the electronic invoice payment system calculates a vendor propensity factor for the subject vendor. The vendor propensity factor operates as a measure of the subject vendor's propensity to participate in an aspect of the electronic invoice payment system.

The vendor propensity factor may take a variety of forms. For example, in a simple form the vendor propensity factor may be a flag indicator stored in a database record indicative that the subject vendor in a general sense has a positive propensity for participating in the electronic invoice payment system by satisfying the one or more predetermined criteria.

A more specific vendor propensity factor alternatively may be calculated. For example, particularly when the one or more predetermined criteria include a multiple or plurality of the predetermined criteria, the vendor propensity factor may be calculated in the form of a calculated ranking that operates as a measure of a degree of compliance with the plurality of the predetermined criteria. For example, a vendor that satisfies all five of a set of predetermined criteria would have a calculated vendor propensity factor of a higher ranking as compared to a vendor that satisfies only two of five predetermined criteria. As a result, in formulating a vendor outreach program, the third party processing entity may tailor outreaches to subject vendors in accordance with the rankings of the vendor propensity factors. Given that outreach resources are finite in nature, the third party processing entity can therefore better allocate outreach resources to concentrate first on vendors with a higher propensity to join in the system, and outreaching to lower propensity vendors as resources ultimately may allow.

In other exemplary embodiments, a more specific vendor propensity factor may be associated with one or more specific aspects of the electronic invoice payment system. In such embodiments, the vendor propensity factor is indicative of the subject vendor's propensity to participate in one or more specific aspects of the electronic invoice payment system. A third party electronic invoice payment system may offer a variety of services to vendors, some of which are referenced above. For example, such systems can schedule and process payments automatically, accelerate and consolidate payments, add security features to payment processing, facilitate the joining of a vendor purchasing consortium, facilitate negotiations with a buyer purchasing consortium, and others. Relatedly, fees charged by the third party invoice processing entity may be based on the nature of the services being provided. Particularly when a multiple or plurality of the predetermined criteria are employed, the vendor propensity factor may be associated with at least one of a plurality different services offered by the electronic invoice payment system, or a fee structure (including, e.g., fee amounts, fee payment periods, and the like) for such service(s). As a result, in formulating a vendor outreach program, the third party processing entity may tailor outreaches to subject vendors in accordance with services and fee structures corresponding to the calculated vendor propensity factors. This also permits the third party processing entity to better allocate outreach resources by tailoring the vendor outreach to services and fee structures to the circumstances of particular subject vendors.

At step 350, the electronic payment system generates a vendor propensity record including the vendor propensity factor for the subject vendor. The vendor propensity record may be a database record in a form that is accessible and viewable by persons within the third party processing entity. For example, referring again to FIG. 1, the processor 40 may generate the vendor propensity record as part of the execution of the vendor propensity analysis application 17. The vendor propensity record may also be stored within the database 118, and particularly within the vendor database 200, and/or accessed by or transmitted to the processing entity workstation 16. As referenced above and described in more detail below, the vendor propensity records then may be employed in formulating and executing a vendor outreach program to solicit vendors for participation in aspects of the electronic invoice payment system.

It will be appreciated that the vendor propensity records may be updated from time to time. Such updates may be initiated manually by a system user or automatically based on a predefined periodic or timed basis. For such updating, the method of FIG. 5 may be repeated for subject vendors. When vendor circumstances change, the vendor propensity records may be updated by any one of adding a vendor propensity record for a subject vendor, deleting a vendor propensity record for a subject vendor, or modifying a vendor propensity record for a subject vendor as appropriate.

As referenced above, the electronic payment system is configured to execute a vendor outreach program. Executing the vendor outreach program may be part of the configuration of the processor 40 executing of the vendor propensity analysis application 17. To execute the vendor outreach program, the processor of the electronic invoice payment system further may be configured to access the vendor propensity record for the subject vendor, extract the vendor propensity factor from the vendor propensity record, and analyze the vendor propensity factor to determine whether the vendor propensity record indicates the subject vendor has a propensity to participate in an aspect of the electronic invoice payment system. When the processor determines that the subject vendor has a propensity to participate in the aspect of the electronic invoice payment system, the processor generates a vendor outreach message as to participation by the subject vendor in the aspect of the electronic invoice payment system. Such operations may be performed as to each aspect of the electronic invoice payment system as to which a subject vendor potentially may participate.

FIG. 6 is a flow chart diagram depicting an overview of an exemplary method of executing a vendor outreach program. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 400 at which the electronic invoice payment system accesses a vendor propensity record. The vendor propensity record would have been generated in accordance with the method of FIG. 5 above. For example, a user within the third party processing entity may access the electronic invoice payment system 9 via the processing entity workstation 16. The user can issue a command signal to cause the processor 40 to execute the vendor propensity analysis application 17 to access a vendor propensity record, which may be stored within the database 118, and particularly within the vendor database 200. Vendor propensity records also may be stored locally on the processing entity workstation 16, or in a separate remote database, and accessed by the electronic invoice payment system 9 via the network interface 21.

At step 410, the electronic payment system extracts the vendor propensity factor from the vendor propensity record. At step 420, the electronic invoice payment system analyzes the vendor propensity factor to determine whether the vendor propensity record indicates the subject vendor has a propensity to participate in a particular aspect of the electronic invoice payment system. As described above, the aspects of the electronic invoice payment system subject to the analysis may include one or more features pertaining to services or fee structures provided by the system. Service aspects of the system may include, for example, any one of automatic scheduling of invoice payments, automatic payment initiation and processing of invoice payments, payment acceleration, payment consolidation, adding security features to payment processing, facilitating the joining of a vendor purchasing consortium, facilitating participation in negotiations with a buyer purchasing consortium, and others. Fee aspects of the service may pertain to a variety of system aspects pertaining to fee structures by which vendors pay service fees to the third party processing entity. Such fee aspects may include, for example, a vendor's willingness to accept certain fee amounts and/or fee payment periods for services that may be offered and provided. It will be appreciated that the various aspects of the electronic invoice payment system described above are but examples. Any suitable aspects may be analyzed for vendor propensities to participate.

If at step 420 the electronic invoice payment system renders a “No” determination, indicating that the vendor does not have a propensity to participate in the particular aspect of the electronic invoice payment system, the method proceeds to step 430. At step 430, the electronic invoice payment system excludes such aspect from being incorporated into the vendor outreach program. If at step 420, however, the electronic invoice payment system renders a “Yes” determination, indicating that the vendor in fact does have a propensity to participate in the particular aspect of the electronic invoice payment system, the method proceeds to step 440. At step 440, the electronic invoice payment system adds or determines that such aspect is to be incorporated into the vendor outreach program.

If will be appreciated that steps 420-440 may be performed as to each pertinent aspect of the electronic invoice payment system that may be applicable to such vendor. Accordingly, at step 450 the electronic invoice payment system determines whether or not there are additional aspects of the electronic invoice payment system to be considered. If at step 450 the electronic invoice payment system renders a “Yes” determination, indicating that there are additional aspects of the electronic invoice payment system to be considered, the method returns to step 420 to analyze such additional aspects. If at step 450, however, the electronic invoice payment system renders a “No” determination, indicating that there are no additional aspects of the electronic invoice payment system to be considered, the method proceeds to step 460.

At step 460, the electronic invoice payment system generates a vendor outreach message as to participation by the subject vendor in one or more aspects of the electronic invoice payment system for which the vendor has a propensity based on the performance of steps 420-440. The content of the vendor outreach message is formulated so as to be used for solicitation or similar outreach to the subject vendor to demonstrate advantages that may be benefit the vendor by participation in the one or more aspects of the electronic invoice payment system. Because the vendor outreach message is based on the determined vendor propensities, the third party processing entity is better positioned to provide an efficient, effective, and targeted solicitation tailored to aspects of the electronic invoice payment system that would most benefit the subject vendor. The described system, therefore, has advantages over conventional systems in which vendor outreach is performed in a non-targeted, cumbersome manner.

The electronic invoice payment system may generate the vendor outreach message as part of the processor 40 executing the vendor propensity analysis application 17. Vendor outreach messages, therefore, may be formatted as an electronic communication such as an email, SMS message, MMS message, or any suitable electronic message format as are known in the art. Vendor outreach messages may be stored in a computer readable storage medium, such as for example as part of the database 118. In exemplary embodiments, therefore, as depicted in step 470 of FIG. 6, the vendor outreach message may be transmitted electronically to a vendor electronic device. Such transmission may occur automatically or in response to a command manually inputted by a user within the third part processing entity, such as via the processing entity workstation 16. Electronic vendor outreach messages may be transmitted by the electronic invoice payment system to the vendor electronic device via the network interface 21. The vendor electronic device that receives the vendor outreach message may be any suitable electronic device, including a computer system such as the vendor workstation of FIG. 3. Suitable vendor electronic devices also include mobile electronic devices, such as laptop or tablet computers, smartphones, and the like as are known in the art.

Hardcopies of vendor outreach messages also may be printed, modified, and collected into a more comprehensive vendor outreach program. In such cases, persons employed by the third processing entity may perform in-person presentations and solicitations to subject vendors. Vendor outreach programs may be developed from the vendor outreach messages for multiple vendors to solicit or sell common services based on vendor categories. It will be appreciated that the scope, format, and content of vendor outreach programs may be tailored to the specific third party processing entity and associated participant and prospective vendors.

FIG. 7 depicts an exemplary graphical user interface (GUI) 492 for use in connection with an electronic invoice payment system. The GUI 492 may be generated by the invoice and payment system 9 for use in conjunction with accessing the system from one or more of a vendor workstation, buyer workstation, or processing entity workstation. For example, the processor 40 may be configured to render display data, using conventional rendering techniques, regarding various invoice information. The display data may be transmitted via the network interface 21, and thereby accessible by a processing entity user, buyer, or vendor using a workstation via the network 20 and/or through the network interface 21. In such a system, the display data would be rendered on a display of the workstation. Inputs may be provided to the GUI via any suitable input device utilized in connection with the computerized workstations, such as a keyboard, mouse, stylus, touch screen, voice commands, and various others as are known in the art of computer based GUIs. The GUI 492 may include category information tabs 494 that pertain to various aspects of invoicing. One such exemplary category tab is “Vendor Outreach” for use in connection with the various vendor propensity analysis and vendor outreach features described herein. It will be appreciated that the GUI of FIG. 7 is an example, and the format and content of the GUI may be varied.

In the example of FIG. 7, the “Vendor Outreach” tab has been selected for usage. Within the GUI, a variety of exemplary command buttons 496 may be provided for a third party processing entity user intending to perform vendor propensity analyses and vendor outreach activity. For example, there may be a command button for “View/Set Vendor Propensity Criteria”. Selecting such button in the GUI may open a sub-GUI page or window that would permit a user to view and enter a variety of vender propensity criteria as described above. For example, such criteria may include the various buyer side analyses and vendor side analyses predetermined criteria as described above.

Another command button may be “Propensity Analysis Engine”. Selecting such button in the GUI may open a sub-GUI page or window that would permit a user to develop and implement vendor propensity analyses. For example, a user may select vendors, related buyers, and associated vendor propensity criteria to tailor and perform vendor propensity analyses. Such portion of the GUI may also result in generation and storage of the vendor outreach messages, and relatedly permit the user to compile and modify the vendor outreach messages to develop the more comprehensive vendor outreach programs.

Another command button may be “Vendor Outreach Data”. Selecting such button in the GUI may open a sub-GUI page or window that would permit a user to view a variety of data pertaining to various aspects of the system. For example, a vendor may view and/or select vendor outreach messages, access historical outreach data and outreach programs, and otherwise monitor vendor outreach activity.

Another command button may be “Alerts”. Selecting such button in the GUI may open a sub-GUI page or window that would permit a user to view and act on alerts pertaining to vendor outreach. For example, the sub-GUI may permit a user to receive alerts that a particular vendor outreach message has been transmitted to a vendor. This permits a user within the third party processing entity to monitor activity that results from vendor propensity analyses. Relatedly, the user may receive alerts as to responses from vendors as to participation in the electronic invoice processing system, including, for example, that a vendor desires to join and participate in one or more aspects of the electronic invoice payment system. In the example of FIG. 7, the alerts button includes a symbol “!”. Such a symbol or comparable may provide notice to a user that new alerts have been received or are present that need action. Other forms of alert notice also may be provided. In addition to various potential visual alerts (e.g., symbols, flashing light or LED, etc.), audible alerts in the form of various alert tones also may be provided so a user is provided notice of receiving an alert even when the user is not viewing the GUI at the precise time the alert is received. It also will be appreciated that a user may not always be at a workstation when an alert is generated, and alerts have substantial time sensitivity. Accordingly, alerts (whether visual or audible) may be transmitted to various electronic devices, and particularly mobile devices (e.g., laptop computers, tablets and tablet computers, smart phones, etc.), so that a user can receive the alerts by numerous means. Such portable devices also may permit opening the sub-GUI for viewing and acting on alerts. In this manner, the system permits prompt action on alerts by a user from a variety of devices to account for the time sensitivity of alerts.

As referenced above, it will be appreciated that the GUI of FIG. 7 is an example, and the format and content of the GUI may be varied.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. An electronic invoice payment system comprising:
a database stored on a non-transitory computer readable medium, the database including a plurality of vendor records containing information pertaining to a plurality of vendors;
a network interface configured to receive presented invoices from multiple vendors for payment by multiple buyers; and
a processor configured to analyze at least a portion of the vendor records to determine whether a subject vendor selected from among the plurality of vendors satisfies one or more predetermined criteria, and when the processor determines that the subject vendor satisfies the one or more predetermined criteria, to calculate a vendor propensity factor that operates as a measure of the subject vendor's propensity to participate in an aspect of the electronic invoice payment system;
wherein the processor further is configured to generate a vendor propensity record including the vendor propensity factor for the subject vendor.

2. The electronic invoice payment system of claim 1, wherein the one or more predetermined criteria comprises criteria based on a buyer side analysis of the portion of the vendor records.

3. The electronic invoice payment system of claim 2, wherein the buyer side predetermined criteria include that the subject vendor shares a common buyer with other vendors participating in the electronic invoice payment system.

4. The electronic invoice payment system of claim 2, wherein the buyer side predetermined criteria include at least one of that the subject vendor presents invoices to a corresponding buyer on a regular periodic basis, that the subject vendor presents invoices to the corresponding buyer above a predefined threshold number of invoices within a predefined time period, or that the subject vendor presents invoices to the corresponding buyer above a predefined threshold value.

5. The electronic invoice payment system of claim 1, wherein the one or more predetermined criteria comprises criteria based on a vendor side analysis of the portion of the vendor records.

6. The electronic invoice payment system of claim 5, wherein the vendor side predetermined criteria include that the subject vendor accepts one or more forms of electronic payment and accepts such electronic payments in a percentage of transactions above a predefined threshold amount.

7. The electronic invoice payment system of claim 5, wherein the vendor side predetermined criteria include that the subject vendor sell products of a predefined product identity.

8. The electronic invoice payment system of claim 5, wherein the vendor side predetermined criteria include that the subject vendor operates within a predefined industry.

9. The electronic invoice payment system of claim 8, wherein the vendor side predetermined criteria include that the subject vendor within the predefined industry is eligible for at least one of joining or negotiating with a purchasing consortium.

10. The electronic invoice payment system of claim 1, wherein the one or more predetermined criteria are stored in the database.

11. The electronic invoice payment system of claim 1, wherein the vendor propensity factor is a flag indicator stored in the database that is indicative that the subject vendor has a positive propensity for participating in the electronic invoice payment system.

12. The electronic invoice payment system of claim 1, wherein the one or more predetermined criteria comprises a plurality of predetermined criteria, and the vendor propensity factor comprises a calculated ranking that operates as a measure of a degree of compliance with the plurality of predetermined criteria.

13. The electronic invoice payment system of claim 1, wherein the vendor propensity factor is indicative of the subject vendor's propensity to participate in one or more aspects of the electronic invoice payment system.

14. The electronic invoice payment system of claim 13, wherein the one or more aspects of the electronic invoice payment system comprises at least one of scheduling payments automatically, processing payments automatically, accelerating payments, consolidating payments, adding security features to payment processing, facilitating the joining of a vendor purchasing consortium, facilitating negotiations with a buyer purchasing consortium, or a fee structure.

15. The electronic invoice payment system of claim 1, wherein when the processor determines that the subject vendor does not satisfy the one or more predetermined criteria, the processor further is configured to exclude the vendor as a candidate for participating in the electronic invoice payment system.

16. The electronic invoice payment system of claim 1, wherein the processor further is configured to update the vendor propensity record.

17. The electronic invoice payment system of claim 1, wherein the processor further is configured to:
access the vendor propensity record for the subject vendor;
extract the vendor propensity factor from the vendor propensity record;
analyze the vendor propensity factor to determine whether the vendor propensity record indicates the subject vendor has a propensity to participate in an aspect of the electronic invoice payment system; and
when the processor determines that the subject vendor has a propensity to participate in the aspect of the electronic invoice payment system, to generate a vendor outreach message as to participation by the subject vendor in the aspect of the electronic invoice payment system.

18. The electronic invoice payment system of claim 17, wherein the processor further is configured to transmit the vendor outreach message to a vendor electronic device via the network interface.
